(19) United States
(12) Patent Application Publication
(10) Pub. No.: US 2005/0289615 A1
(43) Pub. Date: Dec. 29, 2005

(54) Video distribution system, video distribution device, video reception device, video distribution method, video reception method, video distribution program, and video reception program

(75) Inventor: Masanobu Nishitani, Suwa-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/155,607

(22) Filed: Jun. 20, 2005

(30) Foreign Application Priority Data
Jun. 25, 2004 (JP) 2004-188345
Feb. 25, 2005 (JP) 2005-050322

(51) Int. Cl. H04N 7/173

(52) U.S. Cl. 725/88; 725/105; 725/100; 725/131

(57) ABSTRACT

A video delivery system includes: a video delivery device which delivers video data through a network. The video delivery device has a function of generating video data of the same contents as preceding delivery video data and succeeding delivery video data, and a function of delivering the preceding delivery video data and the succeeding delivery video data with a predetermined time difference. The video delivery system also includes a video receiving device which receives the video data delivered from the video delivery device and generates video data to be played back. The video receiving device has a function of receiving the preceding delivery video data and the succeeding delivery video data, a function of checking the preceding delivery video data and the succeeding delivery video data, and a function of generating video data to be played back on the basis of a result of the checking of the preceding delivery video data and the succeeding delivery video data.

### BACKGROUND

The exemplary embodiments relate to a video delivery system, a video delivery device, a video receiving device, a video delivery method, a video receiving method, a video delivery program, and a video receiving program.

In the related art, there are various video delivery systems which deliver and receive video data through a network. Many of these systems deliver and receive video data by one input interface. In order to deliver and receive a video of high accuracy using a general-purpose network, such as, for example, Ethernet, for this input interface, surely and at a high speed, it is desirable that the network is of high quality and has a large capacity.

In the related art, this kind of video delivery system not only gives a large load to the network itself or a video delivery device but also can cause a packet loss in a packet that is video data due to inclusion of noise during data transmission. Further, transmission delay can be produced by a load on the video delivery device, a load on a device constituting an application and the system, and delay of processing.

Related art technology attempts to address these problems, such as the packet loss and the transmission delay. For example, technology capable of playback a video with no data loss on a video receiving device side has been disclosed in Japanese Patent Application Publications 2003-125374 and 2004-7361.

In the technology disclosed in Japanese Patent Application Publication 2003-125374, test data is previously delivered to the video receiving device side, whereby when the sent test data is played back, the video receiving device side transmits information on the video receiving device, such as a drop frame and processing capacity of a CPU, to the video delivery device side. On the other hand, the video delivery device side sets an optimum video delivering condition on the basis of the information on the video receiving device sent from the video receiving device side. Hereby, the packet loss and the transmission delay are avoided.

In the technology disclosed in Japanese Patent Application Publication 2004-7361, plural transmission paths are provided so that paths such as an Internet can be selected. Namely, plural transmission paths are set between two locations which perform data transmission and receiving, and a ratio of data delivery to that path is changed correspondingly to the path state which change momentarily, thereby to prevent the data loss and the data delay due to trouble and congestion of the network.

According to the technology disclosed in Japanese Patent Application Publication 2003-125374 or 2004-7361, it is thought that a certain effect can be expected on the packet loss and the transmission delay.

However, in case of the technology disclosed in Japanese Patent Application Publication 2003-125374, since the load on the network and the conditions of the video delivery device side and the video receiving device side always vary, the delivery condition, set by the measurement result depending on the test data of one, being always optimum, is not warranted. Even if a system, every time test data is periodically delivered, sets the optimum delivery condition, when many video receiving devices exist, the optimum delivery condition must be set for each video receiving device. Thus, processing on the video delivery device side becomes complicated, so that the load applied on the video delivery device side becomes very large.

Further, with the technology disclosed in Japanese Patent Application Publication 2004-7361, there is a problem that the video delivery device must always monitor the condition of the network. Further, as the number of the video receiving devices for receiving data increases, not only does monitoring of the quality of the video receiving device and processing for determining the distribution ratio become complicated, but there is also a problem in that processing on the video delivery device side becomes complicated.

Also, in a real-time video delivery method using a general network, usually, one interface is used. Therefore, when a packet loss is produced, a re-transmission request (ARQ: Automatic Repeat reQuest) is sent from the video receiving device side to the video delivery device side, and the data in which the packet loss is produced is transmitted again from the video delivery device side, so that there is a problem that receiving and transmission of signals on the network becomes complicated.

Further, in this ARQ, the round trip time (RTT: Round Trip Time) of the packet appears as a delay. In this case, naturally, both of the packet loss and the delay become problems, so that there is a problem in that playback quality of the video lowers.

Further, in the related art, as a method of recovering the packet loss in the real-time data transmission, in addition to the ARQ, there is a method of forward error correction (FEC) using error correction coding technology.

In this FEC, a redundant code is given to data to be delivered on the video delivery device side, and in case that the packet loss is produced in the transfer path, the packet in which the packet loss has been produced is recovered by its redundant code. Since this FEC does not require the procedure of the ARQ, the delay can be also reduced correspondingly.

However, in this FEC, it is necessary to always feed the redundant data, so that there is a problem that a network band is redundantly necessary. Therefore, in case that video data of high accuracy is delivered, more network bandwidth are necessary, so that a large load is given on the network.

Further, as another problem, there is a case where the data recovered by the FEC is out playback time. For example, in case that an interval between a video data and a video data recovered by the FEC is large, before the video data recovered by the FEC reaches, the next video data can be played back. This case also causes the problem in playback quality of the video similarly to the case where the packet loss and the delay are produced, which gives a malaise to a user who watches the video.

### SUMMARY

An advantage of the exemplary embodiments are to provide a video delivery system which can deal with problems such as packet loss and transmission delay, and further can perform at least one of the following: reduce loads on a video delivery device and a network; deliver video data of high quality at a high speed and with high reliability on the video delivery device side; and play back the video data of high quality on a video receiving device side. Another advantage of the exemplary embodiments are to provide a video delivery device, a video receiving device, a video delivery method, a video receiving method, a video delivery program, and a video receiving program for constructing this video delivery system.

(1) A video delivery system according to an aspect of the exemplary embodiments include a video delivery device which delivers video data, and a video receiving device which receives the video data delivered from the video delivery device and generates video data to be played back. The video delivery device generates video data of the same contents as preceding delivery video data and succeeding delivery video data, and delivers the preceding delivery video data and the succeeding delivery video data with a predetermined time difference. The video receiving device receives the preceding delivery video data and the succeeding delivery video data, checks the preceding delivery video data and the succeeding delivery video data, and generates video data to be played back on the basis of the check result of the preceding delivery video data and the succeeding delivery video data.

Thus, in the video delivery system according to an aspect of the exemplary embodiments, on the video delivery device side, the video data of the same contents are generated as the preceding delivery video data and the succeeding delivery video data, and the preceding delivery video data and the succeeding delivery video data are delivered with the predetermined time difference. On the video receiving device, the video data to be played back is generated on the basis of a result from the check of the preceding delivery video data and the succeeding delivery video data.

Therefore, according to the video delivery system in the aspect of the exemplary embodiments, the re-transmission request from the video receiving device side is not required. By simply delivering the same video data with the predetermined time difference, the problems of the packet loss and the transmission delay can be solved. As a result, it is possible to reduce the loads on the video delivery device and the network, to deliver the video data of high quality at a high speed and with a high reliability on the video delivery device side, and to play back the video data of high quality on the video receiving device side.

(2) In the video delivery system according to the aspect of the exemplary embodiments, a network for delivering the preceding delivery video data and a network for delivering the succeeding delivery video data are provided individually.

Hereby, the bandwidth of the respective networks can be effectively used, and the video data of high accuracy can be deliverd at a high speed.

(3) A video delivery device according to a second aspect of the exemplary embodiments includes a device to generate video data of the same contents as preceding delivery video data and succeeding delivery video data, and a device to deliver the preceding delivery video data and the succeeding delivery video data with the predetermined time difference.

Thus, in the video delivery device according to the second aspect of the exemplary embodiments, the video data of the same contents are generated as the preceding delivery video data and the succeeding delivery video data, and the preceding delivery video data and the succeeding delivery video data are deliverd with the predetermined time difference.

Therefore, according to the video delivery system in the second aspect of the exemplary embodiments, by simply delivering the same video data with the predetermined time difference, the problems of the packet loss and the transmission delay can be solved. As a result, it is possible to reduce the loads on the video delivery device and the network, and to deliver the video data of high quality at a high speed and with high reliability.

Further, the video delivery device according to the second aspect of the exemplary embodiments can be used as a video delivery device in the video delivery system. Namely, by using the video delivery device according to the second aspect of the exemplary embodiment, the video delivery system can be readily constructed.

(4) In the video delivery device according to the second aspect of the exemplary embodiments, each of the preceding delivery video data and the succeeding delivery video data has a plurality of unit video data, and additional information respectively added to the plurality of unit video data.

Hereby, the check processing in the video receiving device can be appropriately performed. As the additional information, there is, for example, time information. The time information includes a time stamp (time indicating information), a sequence number (number indicating a data position in preceding delivery video data V1 or succeeding delivery video data V2), and synchronization information (information for accomplishing synchronization of plural videos in case that one screen in a multi-display is constituted by the plural videos). Using these time stamp, sequence number, and synchronization information, the check processing can be performed.

(5) The video delivery device according to the second aspect of the exemplary embodiments has further device to provide error correction code processing for at least the preceding delivery video data of the preceding delivery video data and the succeeding delivery video data.

Thus, by providing the error correction code processing for the video data to be delivered, the data error produced by the data loss during data transmission can be appropriately corrected on the video receiving device side. Therefore, it is not necessary to make the re-transmission request from the video receiving device side to the video delivery device side, and the loads on the network and the video delivery device can be reduced. Further, by providing the error correction code processing for the preceding delivery video data, processing such as decoding can be performed precedently on the video receiving device side. Therefore, the check of the preceding delivery video data and the succeeding delivery video data can be efficiently performed.

(6) In the video delivery device according to the second aspect of the exemplary embodiments, the error correction code processing is a forward error correction code processing.

Hereby, since the data error produced by the data loss can be corrected more appropriately, the video data of high quality can be delivered at a high speed and with high reliability.

(7) The video delivery device according to the second aspect of the exemplary embodiments has further a function of providing interleave processing for at least the preceding delivery video data of the preceding delivery video data and the succeeding delivery video data.

Thus, by providing the interleave processing for the video data to be delivered, the data loss during the data transmission can be reduced.

(8) A video receiving device according to a third aspect of the exemplary embodiments has a device to receive the preceding delivery video data which is precedently delivered, to precede delivery video data and succeed delivery video data which are generated from video data of the same contents, and the succeeding delivery video data which is succeedingly delivered. The video receiving device further has a device to check the preceding delivery video data and the succeeding delivery video data and a device to generate video data to be played back on the basis of a result of the check of the preceding delivery video data and the succeeding delivery video data.

Thus, in the video receiving device according to the third aspect of the exemplary embodiments, the video data to be played back is generated on the basis of the check result of the preceding delivery video data and the succeeding delivery video data.

Therefore, according to the video receiving device according to the third aspect of the exemplary embodiments, without the re-transmission request, by simply receiving the same video data with the predetermined time difference, the problems of the packet loss and the transmission delay can be solved. As a result, it is possible to reduce the loads on the video delivery device and the network, and to play back the video data of high quality.

Further, the video receiving device according to the third aspect of the exemplary embodiments can be preferably used as a video receiving device in the video delivery system. Namely, by using the video receiving device, the video delivery system can be readily constructed.

(9) The video receiving device according to the third aspect of the exemplary embodiments has a further device to temporarily store the delivered preceding delivery video data.

Hereby, for the predetermined time from receiving of the preceding delivery video data to receiving of the succeeding delivery video data, the preceding delivery video data is temporarily stored, so that the check of the preceding delivery video data and the succeeding delivery video data can be smoothly performed.

(10) The video receiving device according to the third aspect of the exemplary embodiments has a further device to decode the video data to which error correction code processing has been applied.

Hereby, even in case that the data loss is produced during data transmission, the video data can be corrected to exact video data on the video receiving device side.

(11) The video receiving device according to the third aspect of the exemplary embodiments has a further device to decode the video data to which interleave processing has been applied.

Hereby, the check of the preceding delivery video data and the succeeding delivery video data can be appropriately performed.

(12) In the video receiving device according to the third aspect of the exemplary embodiments, the check of the preceding delivery video data and the succeeding delivery video data is performed by checking whether there is a corresponding relation between additional information included in the preceding delivery video data and additional information included in the succeeding delivery video data, and by checking the unit video data included in the preceding delivery video data and the unit video data included in the succeeding delivery video data in the corresponding relation between the preceding delivery video data and the succeeding delivery video data.

Hereby, the check of the preceding delivery video data and the succeeding delivery video data can be appropriately performed. If the check has been obtained, then their unit video data are compared with each other, and video data to be played back is generated on the basis of the comparison result. Therefore, video data to be displayed at that time can be generated more exactly, and the video data of high quality can be played back.

(13) A video delivery method according to a fourth aspect of the exemplary embodiments includes a step of generating video data of the same contents as preceding delivery video data and succeeding delivery video data, and a step of delivering the preceding delivery video data and the succeeding delivery video data with the predetermined time difference.

Therefore, according to the video delivery method in the fourth aspect of the exemplary embodiments, by simply delivering the same video data with the predetermined time difference, the problems of the packet loss and the transmission delay can be solved. As a result, it is possible to reduce the loads on the video delivery device and the network, and to deliver video data of high quality at a high speed and with high reliability.

Further, the video delivery method according to the fourth aspect of the exemplary embodiments can be used as the video delivery method in the video delivery system and the video delivery device. Namely, by using the video delivery method, the video delivery system and the video delivery device can be readily applied.

(14) A video delivery program embodied on a computer readable medium according to a fifth aspect of the exemplary embodiments includes a procedure which causes a video delivery device to generate video data of the same contents as preceding delivery video data and succeeding delivery video data, and to deliver the preceding delivery video data and the succeeding delivery video data with the a predetermined time difference.

Therefore, in case that the video delivery program according to the fifth aspect of the exemplary embodiments is used in the video delivery device, by simply delivering the same video data with the predetermined time difference, the problems of the packet loss and the transmission delay can be solved. As a result, it is possible to reduce the loads on the video delivery device and the network, and to deliver video data of high quality at a high speed and with high reliability.

Further, the video delivery program according to the fifth aspect of the exemplary embodiments can be used as the video delivery program in the video delivery system and the video delivery device. Namely, by using the video delivery program, the video delivery system and the video delivery device can be readily applied.

(15) A video receiving method according to a sixth aspect of the exemplary embodiments includes receiving preceding delivery video data which is precedently delivered, of the preceding delivery video data and succeeding delivery video data which are generated from video data of the same contents, and the succeeding delivery video data which is succeedingly delivered. The method further includes checking the preceding delivery video data and the succeeding delivery video data, and generating video data to be played back on the basis a result of the check of the preceding delivery video data and the succeeding delivery video data.

Therefore, according to the video receiving method of the sixth aspect of the exemplary embodiments, without the re-transmission request, by simply receiving the same video data with the predetermined time difference, the problems of the packet loss and the transmission delay can be solved. As a result, it is possible to reduce the loads on the video delivery device and the network, and to play back video data of high quality.

Further, the video receiving method according to the sixth aspect of the exemplary embodiments can be used as the video receiving method in the video delivery system and the video receiving device. Namely, by using the video receiving, the video delivery system and the video receiving device can be readily applied.

(16) A video receiving program embodied on a computer readable medium, according to a seventh aspect of the exemplary embodiments includes a program to cause a video receiving device to execute receiving preceding delivery video data which is precedently delivered, of the preceding delivery video data and succeeding delivery video data which are generated from video data of the same contents, and the succeeding delivery video data which is succeedingly delivered. The program also checks the preceding delivery video data and the succeeding delivery video data, and generates video data to be played back on the basis of a result of the check of the preceding delivery video data and the succeeding delivery video data.

Therefore, in case that the video receiving program according to the seventh aspect of the exemplary embodiments is used in the video receiving device, without the re-transmission request, by simply receiving the same video data with the predetermined time difference, the problems of the packet loss and the transmission delay can be solved. As a result, it is possible to reduce the loads on the video delivery device and the network, and to play back video data of high quality.

Further, the video receiving program according to the seventh aspect of the exemplary embodiments can be used as the video receiving program in the video delivery system and the video receiving device. Namely, by using the video receiving program, the video delivery system and the video receiving device can be readily applied.

### BRIEF DESCRIPTION OF THE DRAWINGS

The exemplary embodiments will be described with reference to the accompanying drawings, wherein like numbers reference like elements, and wherein:

FIG. 1 is a schematic of the constitution of a video delivery system according to a first exemplary embodiment;

FIG. 2 is a flowchart of a procedure of video data delivery processing in the first exemplary embodiment;

FIGS. 3A-3C are schematics of time information adding processing of a step S3 in FIG. 2 and FEC processing of a step S4 in FIG. 2;

FIG. 4 is a schematic of processing in which each of six video packets Vp1 (0), Vp1 (1), . . . and Vp1 (5) is divided into plural blocks in interleave processing in an exemplary embodiment;

FIG. 5 is a schematic of interleave processing in an exemplary embodiment;

FIG. 6 is a schematic of a data structure of one Vp1′(0) of six preceding delivery video packets Vp1′(0), Vp1′(1), . . . and Vp1′(5) sent on a network NW1 in an exemplary embodiment;

FIG. 7 is a schematic of a data structure of one Vp2 (0) of six succeeding delivery video packets Vp2 (0), Vp2 (1), . . . and Vp2 (5) which constitute succeeding delivery video data V2 in an exemplary embodiment;

FIG. 8 is a flowchart of a procedure of video data receiving processing in the first exemplary embodiment;

FIGS. 9A-9C are schematics of a concrete check operation of a check unit;

FIG. 10 is a schematic of the constitution of a video delivery system according to a second exemplary embodiment;

FIG. 11 is a flowchart of a procedure of video data delivery processing in the second exemplary embodiment; and

FIG. 12 is a flowchart of a procedure of video data receiving processing in the second exemplary embodiment.

### DETAILED DESCRIPTION OF EMBODIMENTS

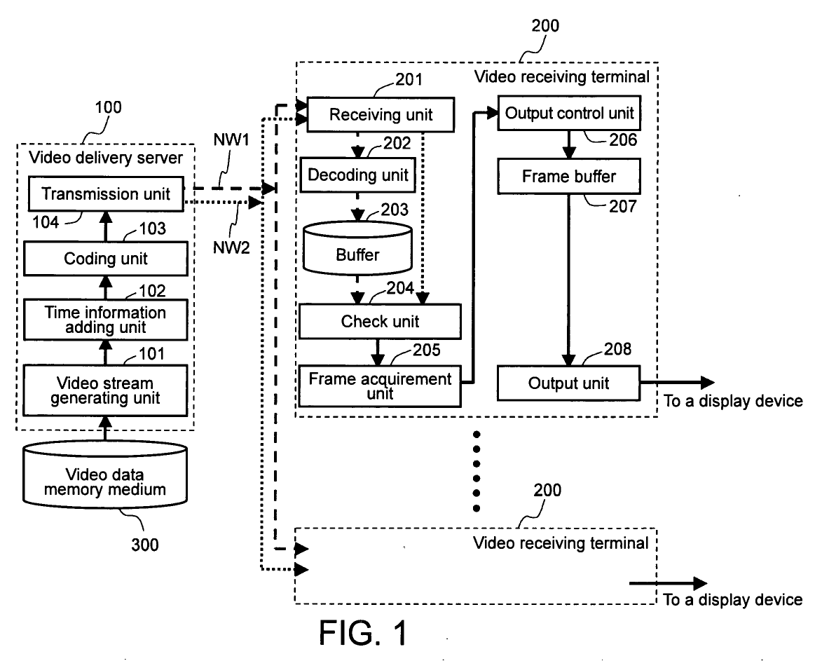

Exemplary embodiments will be described with reference to drawings.

[First exemplary embodiment] FIG. 1 is a schematic of the constitution of a video delivery system according to a first exemplary embodiment. The video delivery system according to the first exemplary embodiment includes a video delivery server 100 as a video delivery device, a plurality of video receiving terminals 200 as a plurality of video receiving devices, two networks NW1 and NW2 interposed between the video delivery server 100 and each video receiving terminal 200, and a video data memory medium 300, which stores video data to be delivered. In FIG. 1, although the video data memory medium 300 is provided separately from the video delivery server 100, the video data memory medium 300 may be provided in the video delivery server 100.

Further, by the two networks NW1 and NW2, the same video data can be delivered with a predetermined time difference.

The video delivery server 100 has a function of generating video data of the same contents as preceding delivery video data and succeeding delivery video data, and a function of delivering these preceding delivery video data and succeeding delivery video data, with the predetermined time difference, to all the video receiving terminals 200 or a specified video receiving terminal 200.

The video delivery server 100 has components to realize the above-described functions including a video stream generating unit 101, a time information adding unit 102 which adds time information as additional information, a coding unit 103 and a transmission unit 104.

The video stream generating unit 101 has a function of acquiring the necessary number of video data (referred to as unit video data) of each predetermined unit from the video data memory medium 300. Of the acquired several unit video data, preceding delivery video data V1 is composed. Similarly, the video stream generating unit 101 generates succeeding delivery video data V2, using the unit video data of the same contents.

Further, the preceding delivery video data V1 and the succeeding delivery video data V2 have a data structure in which time information, as additional information, is added to each unit video data. This data structure will be described later.

The time information adding unit 102 has a function of adding a time stamp, a sequence number, and synchronization information as the time information to the respective unit video data constituting the preceding delivery video data V1 and the succeeding delivery video data V2 generated by the video stream generating unit 101. The time stamp is information which indicates time, the sequence number is a number which indicates a data position of the preceding delivery video data V1 or the succeeding delivery video data V2, and the synchronization information is information for accomplishing synchronization of plural videos when one screen is composed of the plural videos in a multi-display.

The coding unit 103 has a function of applying forward error correction processing (hereinafter referred to as FEC processing) using error correction coding technology to each unit video data to which the time information has been added, constituting the preceding delivery video data V1, and a function of applying interleave processing after the FEC processing.

The transmission unit 104 delivers the preceding delivery video data V1 through the network NW1 to the video receiving terminal 200 that is a delivery address of the video data. Further, the transmission unit 104 has a function of delivering the succeeding delivery video data V2 with the predetermined time difference, after delivery of the preceding delivery video data V1 through the network NW2, to the same video receiving terminal 200 as that in case of delivery of the preceding delivery video data V1. Further, the time difference between the preceding delivery video data V1 and the succeeding delivery video data V2 can be appropriately set.

In the video delivery server 100 according to the first exemplary embodiment, the FEC processing is applied onto only the preceding delivery video data V1. Further, after the FEC processing, the interleave processing (described later) is performed, and the data after the interleave processing is sent to the network NW1, as the preceding delivery video data which is actually delivered. The preceding delivery video data which is actually delivered after the interleave processing is denoted by reference numeral V1′, and referred to as preceding delivery video data V1′.

On the other hand, the video receiving terminal 200 has a function of receiving the preceding delivery video data V1′, which is delivered precedently from the video delivery server 100, and the succeeding delivery video data V2, which is delivered with the predetermined time difference. The video receiving terminal 200 also has a function of temporarily storing the preceding delivery video data V1 by buffering, after decoding the preceding delivery video data V1′ thereby to use the decoded data as the preceding delivery video data V1. The video receiving terminal 200 also has a function of checking the temporarily stored preceding delivery video data V1 and the succeeding delivery video data V2, and a function of generating video data to be played back on the basis of a result of the check between the preceding delivery video data V1 and the succeeding delivery video data V2.

The video receiving terminal 200 has components for realizing the above-described which include functions, a receiving unit 201, which receives the preceding delivery video data V1′, which is delivered precedently from the video delivery server 100 and the succeeding delivery video data V2, which is delivered with the predetermined time difference; a decoding unit 202 which decodes the preceding delivery video data V1′ thereby to use the decoded data as preceding delivery video data V1; a buffer 203 which stores the preceding delivery video data V1 output from the decoding unit 202; a check unit 204 which checks the preceding delivery video data V1 stored in the buffer 203 and the succeeding delivery video data V2; a frame acquirement unit 205, which acquires a frame corresponding to a video to be displayed on the basis of the check result; an output control unit 206, which output-controls the frame acquired by the frame acquirement unit 205; a frame buffer 207 which stores the frame output from the output control unit 206; and an output unit 208 which outputs the frame stored in the frame buffer 207 to a display device.

Further, decoding performed by the decoding unit 202 includes, in addition to decoding processing in which the video data to which the error correction code processing has been applied is decoded, processing in which the video data to which interleave processing has been applied is restored to the video data before interleave processing.

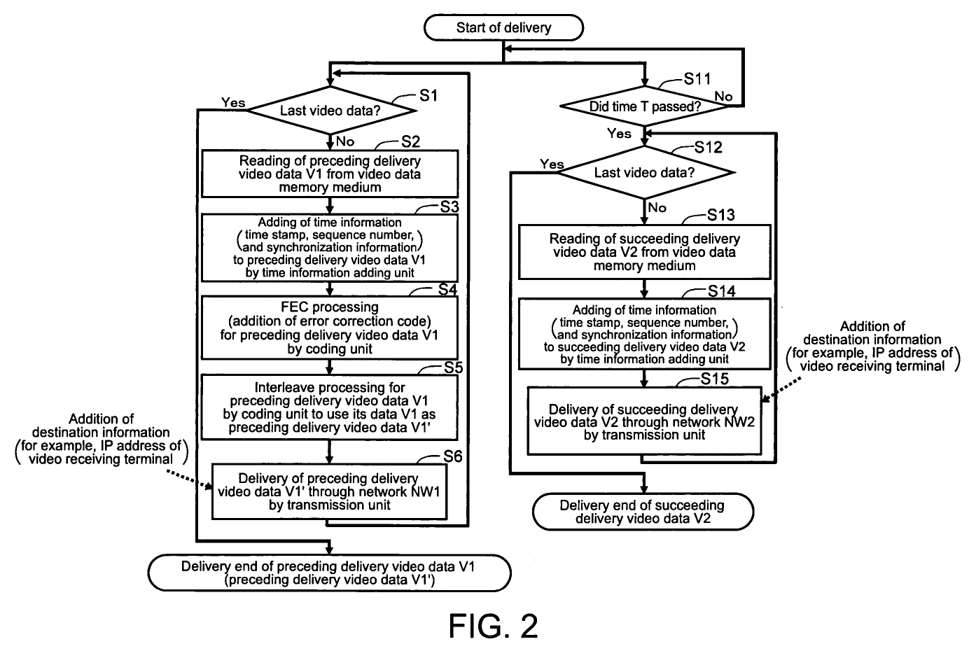

FIG. 2 is a flowchart of a procedure of video data delivery processing in the first exemplary embodiment. In FIG. 2, firstly, whether video data to be delivered last or not is judged (step S1). In case that the video data to be delivered is not the last, the video stream generating unit 101 reads preceding delivery video data V1 from the video data memory medium 300 (step S2). Namely, the video stream generating unit 101 reads a plurality of (six in the first exemplary embodiment and in a second exemplary embodiment described below) unit video data V1 (0), V1 (1), . . . and V1 (5), constituting the preceding delivery video data V1.

Next, to the read preceding delivery video data V1, the time information adding unit 102 adds, as time information, a time stamp, a sequence number, and synchronization information (step S3). Namely, to the respective unit video data V1(0), V1(1), . . . , and V1(5), constituting the preceding delivery video data V1, the time information adding unit 102 adds, as time information, a time stamp, a sequence number, and synchronization information.

Next, the coding unit 103 performs FEC processing for the preceding delivery video data V1 (step S4). Further, this coding unit 103, after the FEC processing, performs interleave processing for the preceding delivery video data V1 (step S5). As described above, this preceding delivery video data V1, to which the interleave processing has been applied, is represented by preceding delivery video data V1′, and this preceding delivery video data V1′ is actually delivered. A concrete example of interleave processing will be described below.

To the preceding delivery video data V1′, destination information (for example, IP address of a video receiving terminal 200) is further added by the transmission unit 104, and its data V1′ is delivered through a first network NW1 to a video receiving terminal 200 that is a destination of delivery (step S6).

Steps S11 to S15 in FIG. 2 are procedures of delivery processing for the succeeding delivery video data V2, which will be described below.

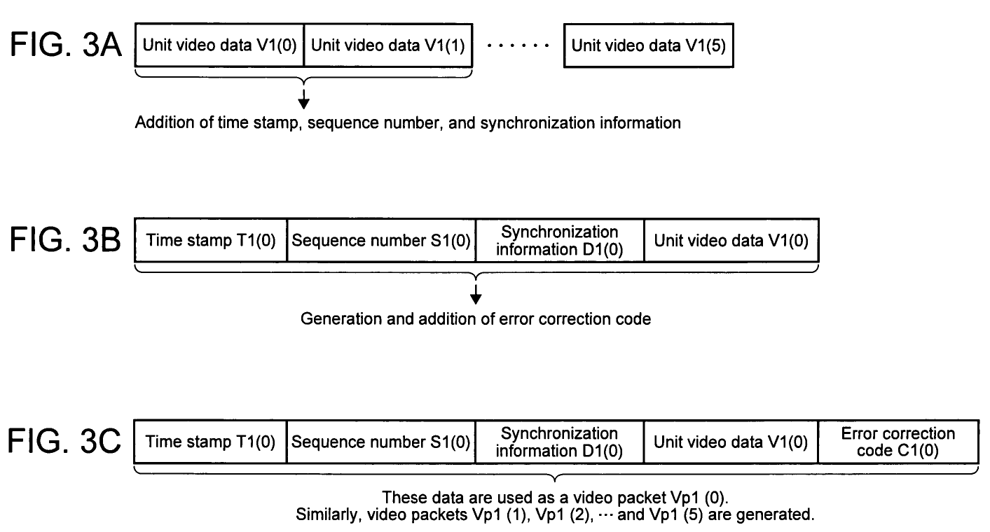

FIGS. 3A-3C are schematics of the time information adding processing in the step S3 of FIG. 2 and the FEC processing in the step S4. In the first exemplary embodiment, since the FEC processing is applied to only the preceding delivery video data V1, the time information adding processing and the FEC processing for the preceding delivery video data V1 will be described.

FIG. 3A shows the six unit video data V1 (0), V1 (1), . . . and V1 (5) constituting the preceding delivery video data V1 acquired from the video data memory medium 300. To these six unit video data V1(0), V1(1), . . . and V1(5), the time information adding processing and the FEC processing are applied to respective unit video data V1(0), V1(1), . . . , and V1(5).

Herein, an example of the time information adding processing and FEC processing for the unit video data V1 (0) of the unit video data V1 (0), V1 (1), . . . and V1 (5) will be described.

The time information adding unit 102, as shown in FIG. 3B, adds a time stamp T1 (0), a sequence number S1 (0), and synchronization information D1 (0), as time information, to the unit video data V1 (0). Then, the coding unit 103 performs the FEC processing for the unit video data V1 (0) to which the time information has been added, and a generated error correction code C1 (0) is added to the unit video data V1 (0), as shown in FIG. 3C. As the FEC processing, various coding can be used. As an example, there is RS (Reed-Solomon) coding.

Processing shown in FIGS. 3A to 3C are also performed for other unit video data V1 (1), V1 (2) . . . , and V1 (5). Hereby, the six video data having the data structure shown in FIG. 3C are generated in total. These six video data are referred to as video packets Vp1 (0), Vp1 (1), . . . and Vp1 (5). Thus, the preceding delivery video data V1 is composed of these six video packets Vp1 (0), Vp1 (1), and Vp1 (5).

When the six video packets Vp1(0), Vp1(1), . . . , and Vp1(5) are thus generated as the preceding delivery video data V1, the coding unit 103 further applies interleave processing to these six video packets Vp1(0), Vp1(1), . . . , and Vp1(5).

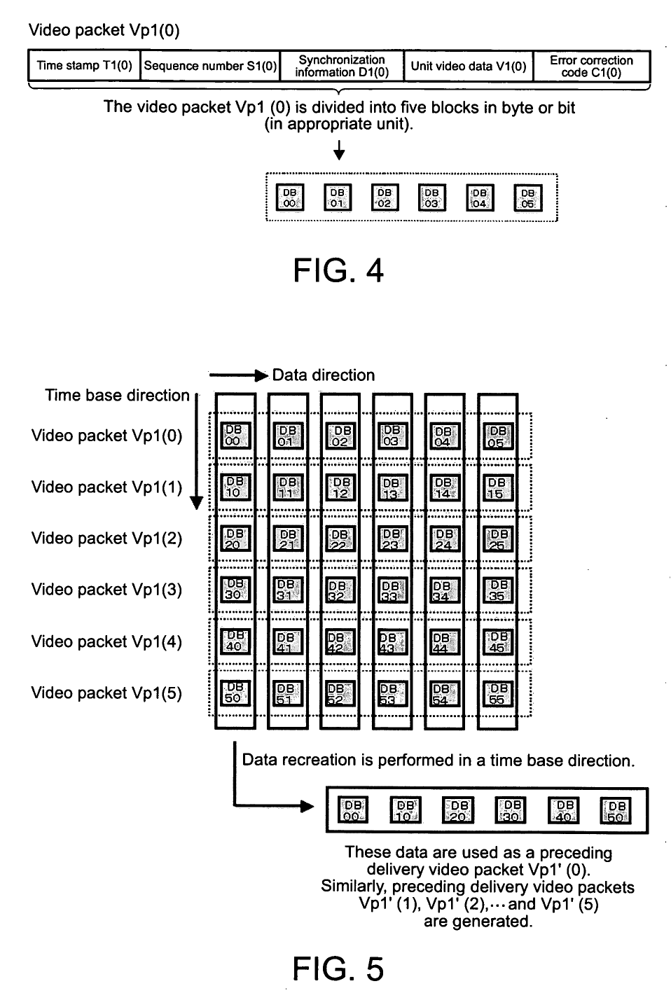

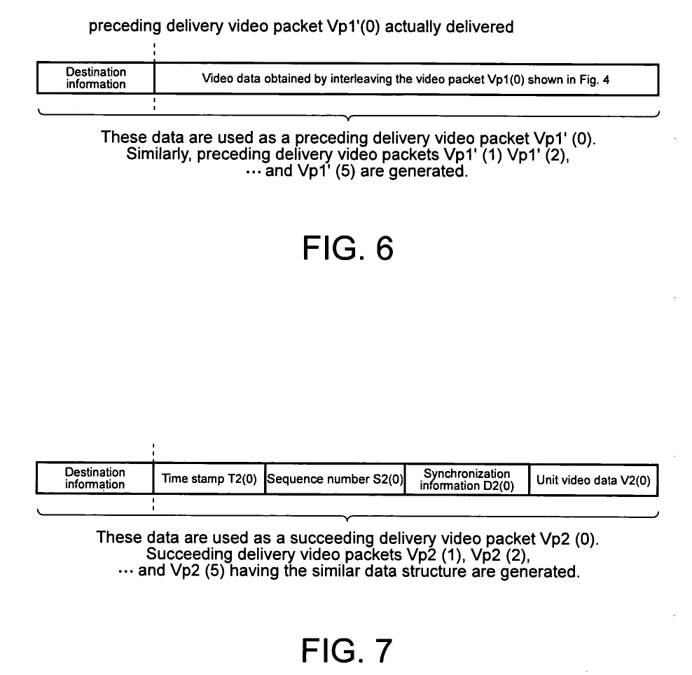

FIG. 4 is a schematic of processing in which the each of six video packets Vp1(0), Vp1(1), . . . and Vp1(5) is divided into plural (herein, six) blocks for interleave processing. FIG. 5 is a schematic of the interleave processing.

In FIG. 4, an example is shown, in which the video packet Vp1 (0) of the six video packets Vp1 (0), Vp1 (1), . . . and Vp1 (5) is divided into six blocks DB00 to DB05. This division into plural data blocks is performed, for example, in an appropriate unit (byte or bit).

In FIG. 4, the division processing is performed for the video packet Vp1 (0), and the similar division processing is also performed for the other five video packets, Vp1 (1), Vp1 (2), . . . and Vp1 (5). Hereby, as shown in FIG. 5, in each of the six video packets Vp1 (0), Vp1 (1), . . . and Vp1 (5), consisting of the preceding delivery video data V1, the six data blocks are generated.

Namely, as shown in FIG. 5, for the video packet Vp1 (0), six data blocks DB00 to DB05 are generated; for the video packet Vp1 (1), six data blocks DB10 to DB15 are generated; and for the video packet Vp1 (5), six data blocks DB50 to DB55 are generated. Thus, for each of the six video packets Vp1 (0), Vp1 (1), . . . and Vp1 (5), the six data blocks are generated.

Of the respective six data blocks DB00 to DB05, DB11 to DB15, . . . , and DB50 to DB55 corresponding to the respective video packets Vp1 (0), Vp1 (1), . . . , and Vp1 (5), the respective first data blocks DB00, DB10, . . . , and DB50 in a time base direction are used to recreate video data, and the recreated video data is used as video packet Vp1′(0).

Similarly, of the six data blocks DB00 to DB05, DB10 to DB15, . . . and DB50 to DB55, the respective second data blocks DB01, DB11, . . . , and DB51 are used to recreate video data, and the recreated video data is used as video packet Vp1′(1).

By repeating this operation, six video packets Vp1′(0), Vp1′(1), . . . , and Vp1′(5) are generated, and these six video packets Vp1′(0), Vp1′(1), . . . , and Vp1′(5) become preceding delivery video data V1′ to be actually delivered. Namely, the preceding delivery video data V1′ to be actually delivered is composed of the six video packets Vp1′(0), Vp1′(1), . . . and Vp1′(5). Hereinafter, these video packets Vp1′(0), Vp1′(1), . . . , and Vp1′(5) are referred to as preceding delivery video packets Vp1′(0), Vp1′(1), . . . , and Vp1′(5).

To the six preceding delivery video packets Vp1′(0), Vp1′(1), . . . , and Vp1′(5) constituting the preceding delivery video data V1′, destination information (for example, IP address of each video receiving terminal 200) is respectively added, and the information added six preceding delivery video packets Vp1′(0), Vp1′(1), . . . , and Vp1′(5) are sequentially fed out on the network NW1.

FIG. 6 is a schematic of data structure of one preceding delivery video packet Vp1′(0) of the six preceding delivery video packets Vp1′(0), Vp1′(1), . . . and Vp1′(5) sent out on the network NW1. The preceding delivery video packet Vp1′(0) is composed of the destination information and the video data obtained by applying the interleave processing to the video packets Vp1 (0) shown in FIG. 4. The other five preceding delivery video packets Vp1′(1), Vp1′(2), . . . Vp1′(5) have also the similar a data structure.

The video data delivery processing for the preceding delivery video data V1 in the video delivery server 100 has been described above. Next, video data delivery processing for the succeeding delivery video data V2 in the video delivery server 100 will be described. The video data delivery processing for this succeeding delivery video data V2 is performed as shown in steps 11 to steps S15 in the flowchart of FIG. 2.

Firstly, after the preceding delivery video data V1 has been delivered as the preceding delivery video data V1′, whether the predetermined time T has passed is judged (step S1). In case that the predetermined time T has passed, whether video data to be delivered (video data to be succeeding delivery video data) exists or not is judged (step S12). Where the video data succeeding delivery video data exists, the procedure performs steps S13 and S14.

Processing in the step S13 is the same as that in the step S2. Processing in the step S14 is the same as that in the step S3. Further, the contents of the read video data are the same as those in the preceding delivery video data V1. By performing the processing in the step S14, six video packets Vp2(0) Vp2(1), . . . , and Vp2(5), composed of time information including a time stamp, a sequence number, and synchronization information, and six unit video data V2(0) V2(1), . . . , and V2(5)are generated.

Of the six video packets Vp2 (0) Vp2 (1), . . . and Vp2 (5), the succeeding delivery video data V2 is composed. Hereinafter, these video packets Vp2(0) Vp2(1), . . . , and Vp2(5) are referred to as succeeding delivery video packets Vp2(0) Vp2(1), . . . , and Vp2(5).

To these six succeeding delivery video packets Vp2 (0) Vp2 (1), . . . , and Vp2 (5), destination information (for example, IP address of each video receiving terminal 200) are respectively added by the transmission unit 104, so that each of succeeding delivery video packets Vp2 (0) Vp2 (1), . . . , and Vp2 (5) becomes video data having data structure shown in FIG. 7 and its video data is sent to the second network NW2.

FIG. 7 is a schematic data structure of one Vp2 (0) of the six succeeding delivery video packets Vp2 (0), Vp2 (1), and Vp2 (5) which constitute the succeeding delivery video data V2. As known from FIG. 7, the succeeding delivery video packet Vp2 (0) is composed of destination information, time information including a time stamp T2 (0), a sequence number S2 (0) and synchronization information D2 (0), and unit video data V2 (0). The other five succeeding delivery video packets Vp2 (1), Vp2 (2), . . . and Vp2 (5) have also the similar data structure.

Next, video data receiving processing on the video receiving terminal 200 side will be described.

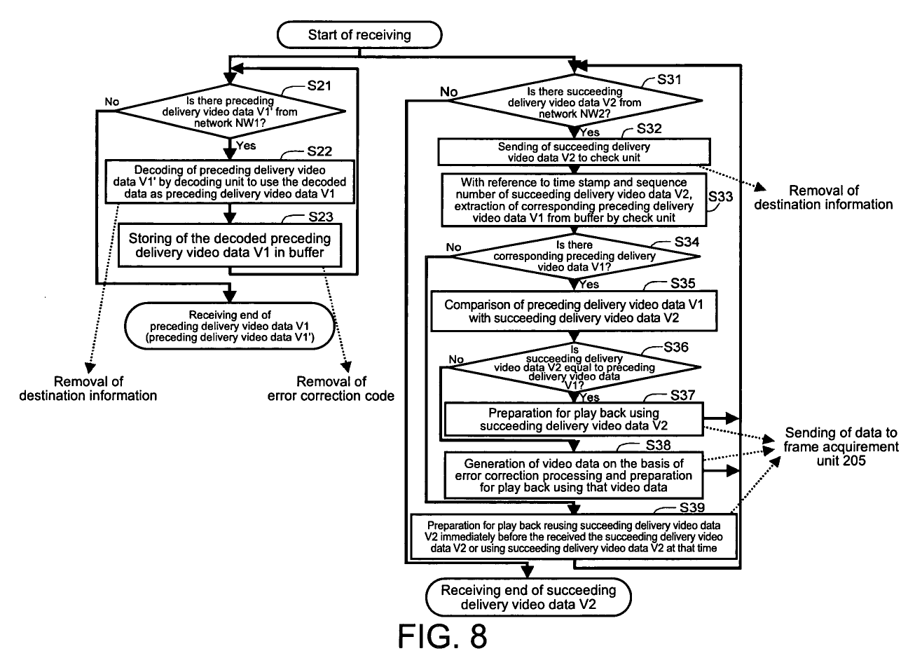

FIG. 8 is a flowchart of a procedure of video data receiving processing of the first exemplary embodiment. Firstly, whether the preceding delivery video data V1′ from the network NW1 exists or not is judged (step S21). In case that the delivered preceding delivery video data V1′ exists, the decoding unit 202 decodes the preceding delivery video data V′ (step S22).

Decoding by the decoding unit 202 is performed for the video data to which the FEC processing and the interleave processing have been applied. Namely, in the first exemplary embodiment, decoding is performed for the six preceding delivery video packets Vp1′(0), Vp1′(1), . . . and Vp1′ (5) constituting the preceding delivery video data V1′.

Decoding obtains the six preceding delivery video packets Vp1 (0), Vp1 (1), and Vp1 (5), before coding, by performing a contrary operation to the coding operation (including the interleave processing) by the coding unit 103 in the video delivery server 100. At this time, by the error correction processing of the FEC, as exact video data as possible is used. Further, the decoding operation is performed in a state where the destination information added to the six preceding delivery video packets Vp1′(0), Vp1′(1), and Vp1′(5) are removed.

Next, the preceding delivery video data V1 decoded by this decoding unit 202 is stored in the buffer 203 (step S23). Namely, the six preceding delivery video packets Vp1 (0), Vp1 (1), . . . and Vp1 (5) constituting the preceding delivery video data V1 are stored in the buffer 203. The six preceding delivery video packets Vp1 (0), Vp1 (1), and Vp1 (5) stored in the buffer 203 are in a state where the destination information and the error correction code by the FEC processing are removed.

Next, whether the succeeding delivery video data V2 from the network NW2 exists or not is judged (step S31). In case that the succeeding delivery video data V2 exists, it is sent to the check unit 204 (step S32). Namely, the respective succeeding delivery video packets constituting the succeeding delivery video data V2 are sequentially sent to the check unit 204.

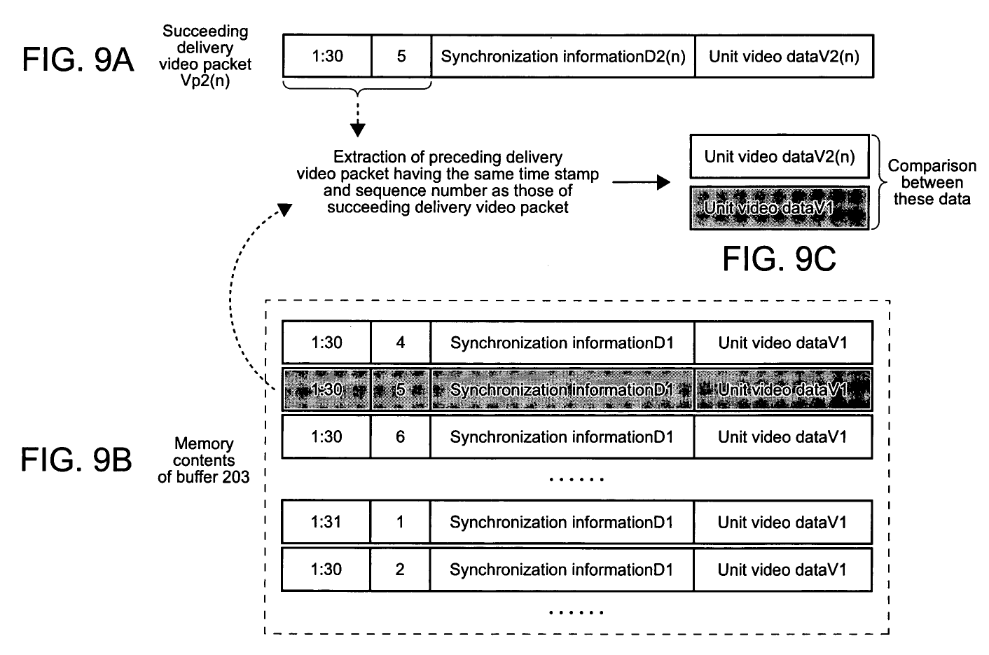

The check operation of the check unit 204 will be described with reference to steps S33 to S39. The particular operation performed by the check unit 204 will be described later with reference to FIG. 9.

Firstly, referring to the time stamp and the sequence number of the succeeding delivery video data V2, the corresponding preceding delivery video data V1 is extracted from the buffer 203 (step S33). If there is the corresponding preceding delivery video data V1 (step S34), the succeeding delivery video data V2 is compared with the corresponding preceding delivery video data V1 (step S35). In case that the succeeding delivery video data V2 is equal to the preceding delivery video data V1 (step S36), the video packet of either of the succeeding delivery video data V2 and the preceding delivery video data V1 may be used. Herein, the succeeding delivery video data V2 is used. Using this succeeding delivery video data V2, preparation for playback is performed (step S37).

On the other hand, in the step S36, in case that the succeeding delivery video data V2 is not equal to the preceding delivery video data V1, preparation for playback is performed using the preceding delivery video data V1 corrected on the basis of the error correction processing (step S38).

On the other hand, in the step S34, in case that it is judged that there is not the corresponding preceding delivery video data V1, since the succeeding delivery video data V2 received at that time is not always exact video data, the succeeding delivery video data V2 immediately before the received the succeeding delivery video data V2 is used again. Alternatively, assuming that the succeeding delivery video data V2 received at that time is exact video data, using the succeeding delivery video data V2, preparation for playback is performed (step S39).

As described above, according to the video receiving terminal 200 in the first exemplary embodiment, the check processing is performed, whereby either the succeeding delivery video data V2 or the preceding delivery video data V1 can be fed to the frame acquirement unit 205 on the basis of that check result. Therefore, video data necessary to display the video data on the display device can be fed more surely to the display device side. Hereby, drop frame can be more surely prevented.

Namely, in case that any problem is produced in the succeeding delivery video data V2, playback can be performed using the preceding delivery video data V1. At this time, the preceding delivery video data V1 is delivered after receiving the FEC processing and the interleave processing on the video delivery server 100 side. Therefore, the video data of high reliability can be played back on the video receiving terminal 200 side. Further, in case that any problem is produced in the preceding delivery video data V1, playback can be also performed using the succeeding delivery video data V2. Hereby, video data necessary to display the video data on the display device can be fed more surely to the display device side.

The processing in the flowchart of FIG. 8 is performed in case that either the succeeding delivery video data V2 or the preceding delivery video data V1 exists. However, a case in which neither the succeeding delivery video data V2 nor the preceding delivery video data V1 can be received is discussed below. In that case, error processing previously set, for example, using the video data of the frame immediately before the present frame as it is, is performed.

FIGS. 9A-9C are schematics of the concrete check operation of the check unit 204. With reference to FIGS. 9A-9C, an example of the concrete operation of the check unit 204 will be described. The check operation for one (represented by succeeding delivery video packet Vp2 (n)) of the six a succeeding delivery video packets Vp2 (0), Vp2 (1), . . . and Vp2 (5) will be described.

In the succeeding delivery video packet Vp2(n), as shown in FIG. 9A, ┌1:30┘ as a time stamp T2(n) of time information, ┌5┘ as a sequence number S2(n), and ┌D2(n)┘ as synchronization information are added to unit video data V2(n). The destination information is removed.

On the other hand, in the buffer 203, the preceding delivery video packets Vp1 (0), Vp1 (1), . . . and Vp1 (5) constituting the preceding delivery video data V1 after decoding are stored. FIG. 9B shows memory contents in this buffer 203.

The check unit 204, on the basis of the time information of one succeeding delivery video packet Vp2(n) as shown in FIG. 9A, extracts, from the preceding delivery video packets stored in the buffer, the preceding delivery video packet that coincides with the succeeding delivery video packet Vp2(n) on the time information. In case of this example, the preceding delivery video packet (shown by a gray portion in FIG. 9B) to which the time stamp ┌1:30┘ and the sequence number ┌5┘ have been added is extracted from the buffer 203.

Next, as shown in FIG. 9C, the unit video data V2(n) of the succeeding delivery video packet Vp2(n) is compared with the unit video data of the preceding delivery video packet extracted from the buffer 203. This processing corresponds to the step S35 of the flowchart in FIG. 8, and the processing according to the flowchart in FIG. 8 is sequentially performed.

Next, the check unit 204 sends the video packet on the basis of the check result to the frame acquirement unit 205. For example, in the example of FIGS. 9A-9C, as a result of the comparison between the unit video data V2 (n) of the succeeding delivery video packet Vp2 (n), and the unit video data of the preceding delivery video packet extracted from the buffer 203, in the case that their unit video data coincide with each other, that succeeding delivery video packet Vp2 (n) is sent to the frame acquirement unit 205. By performing this operation for the succeeding delivery video packets Vp2 (n) sequentially delivered, the video packets of one frame necessary for display are input to the frame acquirement unit 205.

The frame acquirement unit 205, on the basis of the time stamp and the sequence number included in the video packets sequentially received, generates a display frame, and the generated display frame is sent to the frame buffer 207 by the output control unit 206. Further, the output control unit 206 sends the video data of one frame, which is decompressed in the frame buffer 207 on the basis of the synchronization information D2 (n), to the output unit. Hereby, the output unit 208 sends the sent video data to the display device, so that the video is displayed on the display device.

In the video delivery server 100 in the first exemplary embodiment, the interleave processing is applied to only the preceding delivery video data V1 to which the FEC processing has been applied. However, in spite of the presence and absence of the FEC processing, the interleave processing may be performed. For example, in the first exemplary embodiment, the interleave processing may be performed also for the succeeding delivery video data V2. Hereby, loss of the succeeding delivery video data can be reduced. Further, in case that the interleave processing is thus also performed for the succeeding delivery video data V2, the succeeding delivery video data V2 which has received the interleave processing receives, in the decoding unit 202 of the video receiving terminal 200, processing of restoring its succeeding delivery video data V2 to the succeeding delivery video data V2 before the interleave processing.

[Second exemplary embodiment] Although the FEC processing is applied to only the preceding delivery video data V1 in the first exemplary embodiment, it is applied also to the succeeding delivery video data V2 in a second exemplary embodiment.

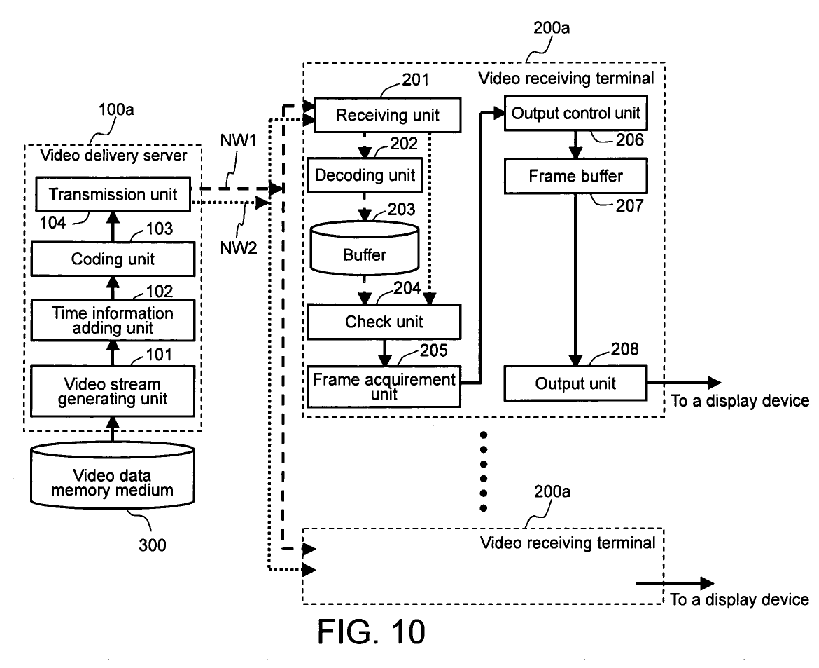

FIG. 10 is a schematic of the constitution of a video delivery system according to the second exemplary embodiment. The constitution in FIG. 10 is different from the constitution in FIG. 1 in that decoding is performed also for succeeding delivery video data V2 on a video receiving terminal 200a side. Since components are the same as those in FIG. 1, each component is denoted by the same reference numeral.

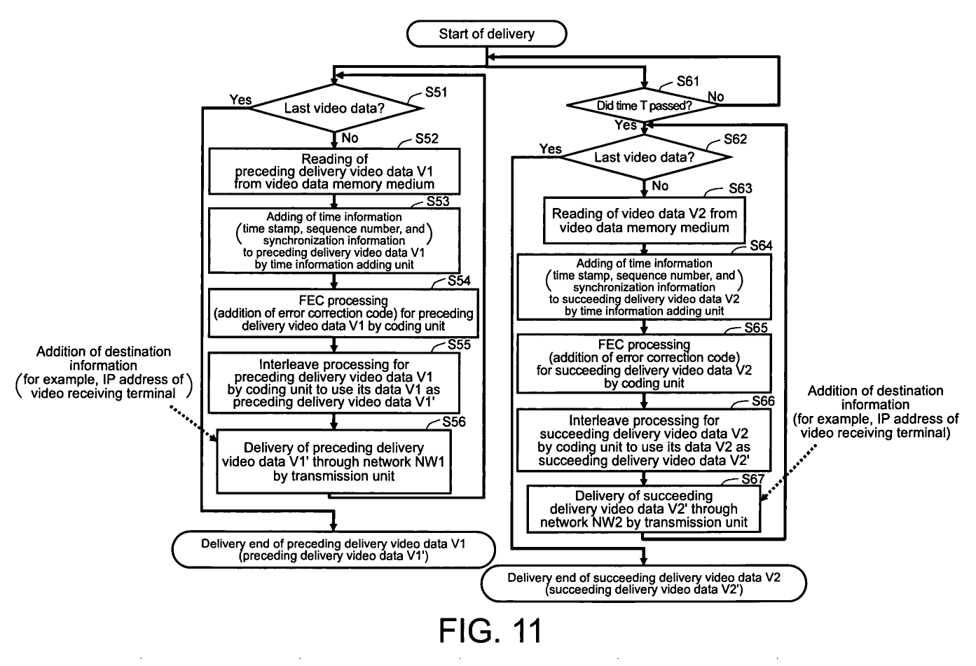

FIG. 11 is a flowchart of a procedure of video data delivery processing in the second exemplary embodiment. Steps S51 to S56 in the flowchart of FIG. 11 are processing for the preceding delivery video data V1, and these steps are the same as the steps S1 to S6 in the flowchart of FIG. 2. Further, steps S61 to S67 in the flowchart of FIG. 11 are processing for the succeeding delivery video data V2, and the steps S61 to S64 of these steps S61 to S67 are the same as the steps S11 to S14 in the flowchart of FIG. 2.

In a video delivery server 100a according to the second exemplary embodiment, FEC processing and interleave processing are performed also for the succeeding delivery video data V2. Therefore, in addition to the succeeding delivery video data V2, similar to the case of the preceding delivery video data V1, FEC processing (step S65) and interleave processing (step S66) by a coding unit 103 are applied. Since the FEC processing and the interleave processing have been described in the first exemplary embodiment, their description is omitted herein.

By thus applying the FEC processing (step S65) and the interleave processing (step S66) to the succeeding delivery video data V2, six succeeding delivery video packets Vp2′(0), Vp2′(1), . . . and Vp2′(5) are generated, these become succeeding delivery video data V2′ actually delivered, and this succeeding delivery video data V2′ is delivered through a network NW2 (step S67).

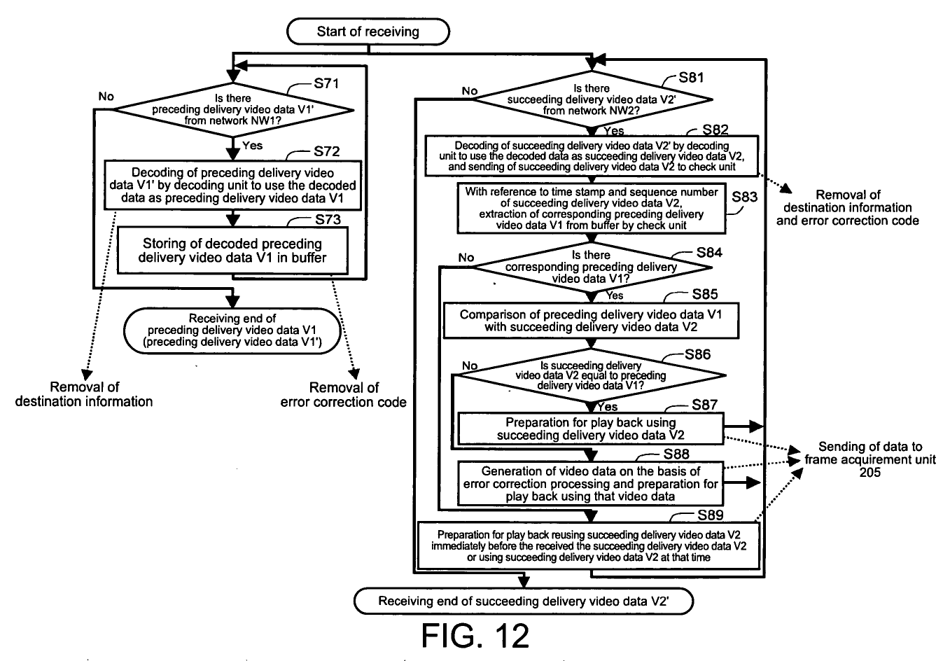

FIG. 12 is a flowchart of a procedure of video data receiving processing in the second exemplary embodiment. Steps S71 to S73 in FIG. 12 are the same as the steps S21 to S23 in FIG. 8. Further, the step S81 to S89 are receiving processing for the succeeding delivery video data V2′, and they are the same as the steps S31 to S39 in FIG. 8 in general. However, in the second exemplary embodiment, the succeeding delivery video data V2′ is the video data to which the FEC processing and the interleave processing have been applied. Therefore, processing in the step S82 of FIG. 12 corresponding to processing in the step S32 of FIG. 8 includes decoding the succeeding delivery video data V2′ (including processing in which data after the interleave processing is restored to the data before the interleave processing) into the succeeding delivery video data V2, and sending the succeeding delivery video data V2 to the check unit 204.

Further, in a step S86 of FIG. 12, in case that the succeeding delivery video data V2 is not equal to the preceding delivery video data V1, preparation for playback may be performed using the preceding delivery video data V1, or preparation for playback may be performed using the succeeding delivery video data V2 (step S89).

Since the FEC processing and the interleave processing are performed not only for the preceding delivery video data V1 but also for the succeeding delivery video data V2, video data delivery having higher reliability for the packet loss can be performed.

The exemplary embodiments are not limited to the above-described embodiments but can be embodied in various modifications without departing from the spirit and scope of the invention.

For example, though the interleave processing in each exemplary embodiment is performed by arranging the first data blocks in the time base direction, the exemplary embodiments are not limited to this but various arrangement can be set by previously setting a rule.

Further, in each exemplary embodiment, the two networks (networks NW1, NW2) are provided, and the preceding delivery video data and the succeeding delivery video data are individually delivered using these two networks. However, the exemplary embodiments are not limited to this, but the preceding delivery video data and the succeeding delivery video data may be delivered with time difference using one network.

Further, a video delivery program and/or a video receiving program in which a processing procedure to realize a video delivery method or a video receiving method used in the video delivery system, the video delivery device or the video receiving device of the exemplary embodiment, is written can be created and their programs can be also stored in a recording medium such as a flexible disc, an optical dick, or a hard disk. Therefore, the exemplary embodiments includes these video delivery program and video receiving program, and also the recording medium which stores the video delivery program and/or the video receiving program. Naturally, the video delivery program and/or the video receiving program can be delivered through the network.

1. A video delivery system, comprising:
a video delivery device which delivers video data, the video delivery device generating video data of the same contents as preceding delivery video data and succeeding delivery video data, and delivering the preceding delivery video data and the succeeding delivery video data with a predetermined time difference; and
a video receiving device which receives the video data delivered from the video delivery device and generates video data to be played back, the video receiving device receiving the preceding delivery video data and the succeeding delivery video data, checking the preceding delivery video data and the succeeding delivery video data, and generating video data to be played back on the basis of a result of the checking of the preceding delivery video data and the succeeding delivery video data.

2. The video delivery system according to claim 1, further comprising:
two networks that are individually provided including, a network that delivers the preceding delivery video data and a network that delivers the succeeding delivery video data.

3. A video delivery device, comprising:
a device that generates video data having a same content as preceding delivery video data and succeeding delivery video data, and
a device that delivers the preceding delivery video data and the succeeding delivery video data with a predetermined time difference.

4. The video delivery device according to claim 3, each of the preceding delivery video data and the succeeding delivery video data having a plurality of unit video data, and having additional information respectively added to the plurality of unit video data.

5. The video delivery device according to claim 3, further comprising:
a device that provides error correction code processing for at least the preceding delivery video data of the preceding delivery video data and the succeeding delivery video data.

6. The video delivery device according to claim 5, the error correction code processing being forward error correction code processing.

7. The video delivery device according to claim 3, further comprising:
a device that provides interleave processing for at least the preceding delivery video data of the preceding delivery video data and the succeeding delivery video data.

8. A video receiving device, comprising:
a device that receives from preceding delivery video data and succeeding delivery video data which are generated from video data of the same contents, preceding delivery video data which is precedently delivered and the succeeding delivered video data which is succeedingly delivered;
a device that checks the preceding delivery video data and the succeeding delivery video data; and
a device that generates video data to be played back on the basis of the check result of the preceding delivery video data and the succeeding delivery video data.

9. The video receiving device according to claim 8, further comprising:
a device that stores the delivered preceding delivery video data temporarily.

10. The video receiving device according to claim 8, further comprising: a device that decodes the video data to which error correction code processing has been applied.

11. The video receiving device according to claim 8, further comprising:
a device that decodes the video data to which interleave processing has been applied.

12. The video receiving device according to claim 8, the check of the preceding delivery video data and the succeeding delivery video data being performed by checking whether there is a corresponding relation between additional information included in the preceding delivery video data and additional information included in the succeeding delivery video data, and by checking the unit video data included in the preceding delivery video data and the unit video data included in the succeeding delivery video data in the corresponding relation between the preceding delivery video data and a the succeeding delivery video data.

13. A video delivery method, comprising:
generating video data of the same contents as preceding delivery video data and succeeding delivery video data, and
delivering the preceding delivery video data and the succeeding delivery video data with a predetermined time difference.

14. A video delivery program embodied on a computer readable medium, comprising:
a program to cause video delivery device to generate video data of the same contents as preceding delivery video data and succeeding delivery video data, and todeliver the preceding delivery video data and the succeeding delivery video data with a predetermined time difference.

15. A video receiving method, comprising:
receiving preceding delivery video data which is precedently delivered, of the preceding delivery video data and succeeding delivery video data which are generated from video data of the same contents, and the succeeding delivery video data which is succeedingly delivered;
checking the preceding delivery video data and the succeeding delivery video data; and
generating video data to be played back on the basis of the check result of the preceding delivery video data and the succeeding delivery video data.

16. A video receiving program embodied on a computer readable medium, comprising:
a program to cause a video receiving device to receive preceding delivery video data which is precedently delivered, of the preceding delivery video data and succeeding delivery video data which are generated from video data of the same contents, and the succeeding delivery video data which is succeedingly delivered, and to check the preceding delivery video data and the succeeding delivery video data, and to generate video data to be played back on the basis of the check result of the preceding delivery video data and the succeeding delivery video data.
